(19) United States
(12) Patent Application Publication
(10) Pub. No.: US 2026/0278039 A1
(43) Pub. Date: Sep. 17, 2026

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Kosuke KINOSHITA, Tokyo (JP); Takahiro KUMURA, Tokyo (JP); Yoshiyuki YAJIMA, Tokyo (JP)

(73) Assignee: NEC Corporation, Tokyo (JP)

(21) Appl. No.: 19/472,782

(22) PCT Filed: Apr. 4, 2024
(86) PCT No.: PCT/JP2024/013959

§ 371 Date: Oct. 6, 2025

(30) Foreign Application Priority Data
Apr. 12, 2023 (JP) 2023-064663

(51) Int. Cl. G06F 17/18

(52) U.S. Cl. CPC G06F 17/18

(57) ABSTRACT

This information processing device comprises: a reference displacement calculation unit for calculating reference displacement data on the basis of displacement data, which has been measured in a target period and which pertains to one or more substructures that are similar to an evaluation target sub-structure constituting a target structure; a difference calculation unit for using the reference displacement data and evaluation target displacement data which pertains to a prescribed portion of the evaluation target sub-structure to calculate displacement difference data; an estimation unit for using the displacement difference data to estimate a probability distribution of a displacement difference of the evaluation target sub-structure; and a diagnosis unit for using the estimated probability distribution of the displacement difference to perform a statistical analysis process and diagnosing the soundness of the sub-structure on the basis of the result of the process.

### TECHNICAL FIELD

The present disclosure relates to an information processing apparatus and an information processing method of diagnosing soundness of a structure, and further relates to a computer-readable recording medium storing a program for achieving the information processing apparatus and the information processing method.

### BACKGROUND ART

It is generally said that service life of structures such as bridges is approximately 50 years. Many of the structures have been maintained all together in the high growth period (1960s), and the service life thereof has expired. Therefore, it is necessary to evaluate soundness of many of the structures. Meanwhile, the number of workers who diagnose the soundness has been decreasing year by year. Therefore, there is a demand for diagnosing soundness of a structure without relying on human hands.

As a related technique, PTL 1 discloses a system for evaluating a degree of deterioration of a structure on the basis of displacement of the structure. According to the system of PTL 1, an original displacement amount of an observation point set in a structure is calculated using a positioning satellite, a corrected displacement amount is calculated by removing a temperature correction value from the original displacement amount, and a deterioration degree of an object is evaluated in stages according to the corrected displacement amount.

### CITATION LIST

### Patent Literature

PTL 1: JP 2021-117007 A

### SUMMARY OF INVENTION

### Technical Problem

In PTL 1 described above, it is assumed that the relationship between the temperature and the displacement of the structure can be expressed by a function. However, in reality, it is difficult to obtain such a function. In addition, such a premise may not be established. For example, when there is an influence (unevenness or variation) of the temperature of the structure, the relationship between the temperature and the displacement of the structure may not be expressed by a simple function.

Furthermore, the influence of the active load on the displacement of the structure may be larger than the influence of the temperature of the structure.

In such a case, in the technique of PTL 1, it is difficult to diagnose the soundness of the target structure even if the temperature correction value is calculated. That is, in PTL 1, it is not possible to diagnose the soundness of the structure when the dominant influence factor of the structure displacement is not the temperature.

An example of the object of the present disclosure is to diagnose the soundness of a structure without performing temperature correction.

### Solution to Problem

In order to achieve the above object, an information processing apparatus according to one aspect of the present disclosure includes
a reference displacement calculation unit for calculating reference displacement data based on displacement data, measured in a target period, of at least one substructure similar to an evaluation target substructure constituting a target structure,
a difference calculation unit for calculating displacement difference data by using evaluation target displacement data of a predetermined portion in the evaluation target substructure and the reference displacement data,
an estimation unit for estimating a probability distribution of a displacement difference of the evaluation target substructure using the displacement difference data, and
a diagnosis unit for performing statistical analysis processing using the estimated probability distribution of the displacement difference and diagnosing soundness of the substructure based on a processing result.

In order to achieve the above object, an information processing method according to one aspect of the present disclosure includes
calculating reference displacement data based on displacement data, measured in a target period, of at least one substructure similar to an evaluation target substructure constituting a target structure,
calculating displacement difference data by using evaluation target displacement data of a predetermined portion in the evaluation target substructure and the reference displacement data,
estimating a probability distribution of a displacement difference of the evaluation target substructure using the displacement difference data, and
performing statistical analysis processing using the estimated probability distribution of the displacement difference and diagnosing soundness of the substructure based on a processing result.

In order to achieve the above object, a computer-readable recording medium according to one aspect of the present disclosure stores a program
causing a computer to
calculate reference displacement data based on displacement data, measured in a target period, of at least one substructure similar to an evaluation target substructure constituting a target structure,
calculate displacement difference data by using evaluation target displacement data of a predetermined portion in the evaluation target substructure and the reference displacement data,
estimate a probability distribution of a displacement difference of the evaluation target substructure using the displacement difference data, and
perform statistical analysis processing using the estimated probability distribution of the displacement difference and diagnose soundness of the substructure based on a processing result.

### Advantageous Effects of Invention

As described above, according to the present disclosure, it is possible to diagnose the soundness of a structure without performing temperature correction.

### BRIEF DESCRIPTION OF DRAWINGS

FIG. 1 is a diagram for describing an example of an information processing apparatus.

FIG. 2 is a diagram for describing an example of a system including the information processing apparatus.

FIG. 3 is a diagram for describing an example of a structure.

FIG. 4 is a diagram for describing an example of displacement data.

FIG. 5 is a diagram for describing an example of graphing of the displacement data.

FIG. 6 is a diagram for describing an example of a relationship between displacement data and reference displacement data in calculation of reference displacement data.

FIG. 7 is a diagram for describing an example of calculation of the reference displacement data.

FIG. 8 is a diagram for describing an example of a probability distribution of a displacement difference.

FIG. 9 is a diagram for explaining an example of a displacement function obtained by curve fitting of the displacement data.

FIG. 10 is a diagram for explaining an example of a probability distribution of a displacement difference in Second modified example.

FIG. 11 is a diagram for describing an example of the operation of the information processing apparatus.

FIG. 12 is a diagram for describing an example of a computer that achieves an information processing apparatus according to an example embodiment and a modified example.

### EXAMPLE EMBODIMENT

### Example Embodiment

Hereinafter, an example embodiment will be described with reference to the drawings. In the drawings described below, elements having the same function or relevant functions are denoted by the same reference signs, and repeated description thereof may be omitted.

### [Apparatus Configuration]

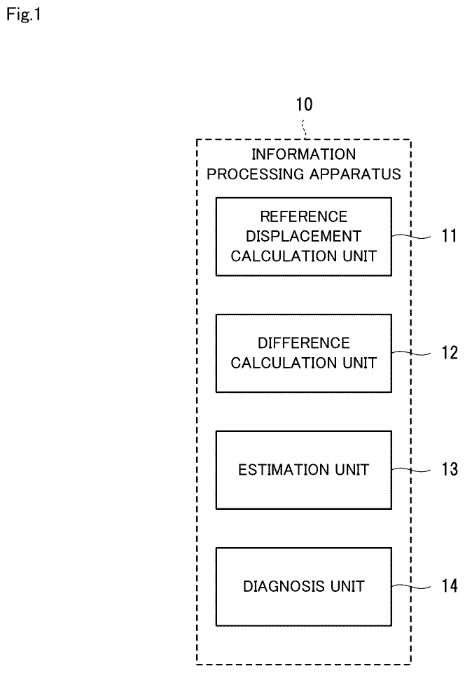

A configuration of an apparatus (soundness diagnosis apparatus) that diagnoses soundness of a structure without performing temperature correction will be described as an information processing apparatus according to an example embodiment with reference to FIG. 1. FIG. 1 is a diagram for explaining an example of an information processing apparatus.

Examples of the structure include structures constructed using a cured product (concrete, mortar, or the like), solidified using at least sand, water, and cement, a metal, or the both. The structure is the entire building or a part thereof. Further, the structure is the entire machinery or a part thereof.

A structure is an assembly of substructures of similar structural type. In addition, when each of the plurality of substructures is affected by the same environmental factor, similar displacement occurs. For example, when the structure is a bridge, the substructure is an assembly in which a plurality of spans (substructures representing a portion between a bridge pier and a bridge pier) are connected. Also, the multiple spans are exposed to similar temperature environments, traffic loads, and generate displacements in the same way.

The relationship between the structure and the substructure is not limited to the bridge and the span, and can be applied to other structures. The other structures are, for example, structures that can be regarded as an assembly of substructures having a structure form similar to each other, such as a dam, a gas tank, and a building. For example, in the case of a building, each layer is a substructure.

In the following description, a bridge will be used as an example of a structure for easy understanding of the description.

The information processing apparatus 10 illustrated in FIG. 1 diagnoses the soundness of an arbitrary evaluation target substructure of a structure. Further, the diagnosis of the soundness includes anomaly detection. The information processing apparatus 10 includes a reference displacement calculation unit 11, a difference calculation unit 12, an estimation unit 13, and a diagnosis unit 14.

The reference displacement calculation unit 11 calculates reference displacement data based on displacement data, measured in a target period, of at least one substructure similar to an evaluation target substructure constituting a target structure.

The difference calculation unit 12 calculates displacement difference data by using displacement data of a predetermined portion (evaluation target displacement data) in the evaluation target substructure and the reference displacement data.

The estimation unit 13 estimates a probability distribution of a displacement difference of the evaluation target substructure using the displacement difference data. Hereinafter, the probability distribution of the displacement difference of the evaluation target substructure may be simply referred to as “probability distribution”.

The diagnosis unit 14 performs statistical analysis processing using the estimated probability distribution of the displacement difference and diagnoses soundness of the substructure based on a processing result.

Specifically, the diagnosis unit 14 diagnoses whether there is an abnormality (aged deterioration, damage, etc.) in the displacement of the substructure on the basis of the processing result of the verification processing of calculating the distance between the average value of the probability distribution and a preset zero (value indicating soundness). Alternatively, the structure parameter of the substructure may be estimated by statistical analysis processing of reproducing the probability distribution by simulation, and whether there is an abnormality of the substructure may be diagnosed.

In any of the processes described above, the diagnosis unit 14 diagnoses the soundness of the evaluation target substructure by the processing result of the statistical analysis processing such as the verification process using the probability distribution of the displacement difference.

As described above, in the example embodiment, attention is paid to the displacement of the plurality of substructures constituting the structure, the reference displacement is calculated using the displacement of the substructure other than the evaluation target, and the deviation degree of the displacement of the evaluation target substructure with respect to the reference displacement is evaluated by the probability distribution of the displacement difference.

Therefore, in the example embodiment, since the reference displacement assumed to be sound is calculated using the displacement of the substructure other than the evaluation target, it is possible to diagnose the soundness of the structure without correcting the displacement by temperature (temperature correction).

### [System Configuration]

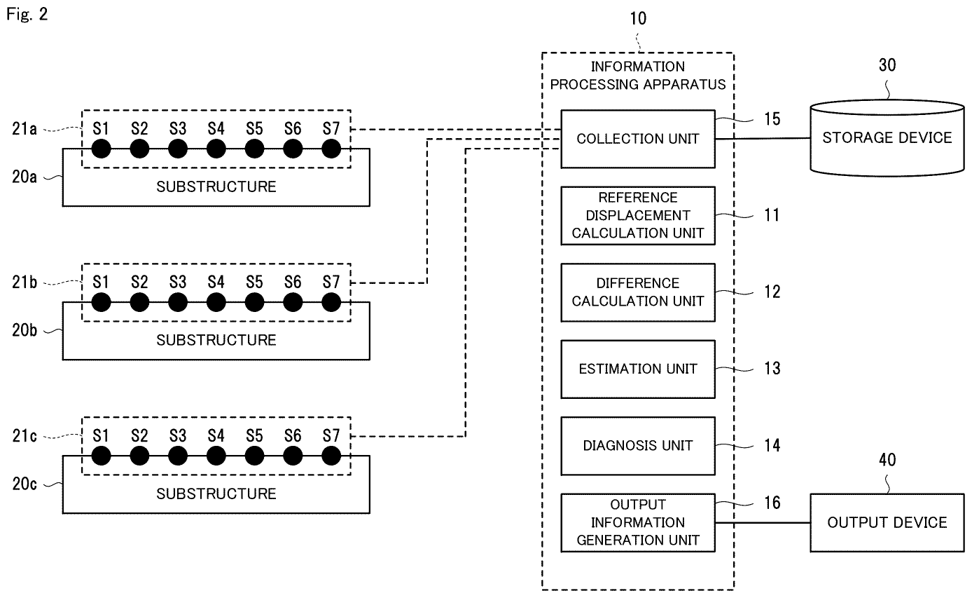

The configuration of the information processing apparatus 10 according to the example embodiment will be described more specifically with reference to FIG. 2. FIG. 2 is a diagram for describing an example of a system including the information processing apparatus.

As illustrated in FIG. 2, the system including the information processing apparatus 10 according to the example embodiment includes the information processing apparatus 10, a plurality of observation points 21 (21a, 21b, 21c), a storage device 30, and an output device 40. The information processing apparatus 10 includes the reference displacement calculation unit 11, the difference calculation unit 12, the estimation unit 13, the diagnosis unit 14, a collection unit 15, and an output information generation unit 16.

The information processing apparatus 10 is, for example, an information processing apparatus such as a circuit, a server computer, a personal computer, or a mobile terminal equipped with at least one of a central processing unit (CPU), a programmable device such as a field-programmable gate array (FPGA), a graphics processing unit (GPU), or any one of these.

A substructure 20 (20a, 20b, 20c) is a component constituting a target structure. The substructures 20a, 20b, and 20c have structural forms similar to each other. The substructures 20a to 20c may be substructures constituting a structure other than the target structure as long as the factors are the same (temperature, traffic volume, and the like are the same) and can be expressed in a similar structure form.

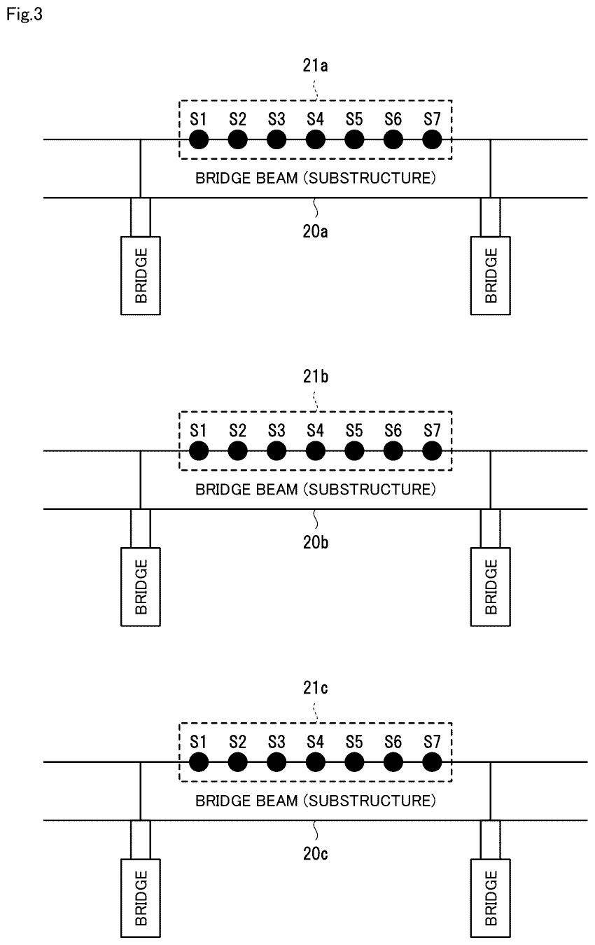

The substructures 20a to 20c are, for example, structures between bridge piers. The structure between the bridge piers is a span, a bridge beam between the bridge piers, or the like. FIG. 3 is a diagram for describing an example of the substructure. In the example of FIG. 3, each bridge beam is the substructure 20, but the substructure 20 is not limited to the bridge beam. Although there are three substructures 20a to 20c in FIG. 3, the number is not limited to three, and there may be two or more than three substructures 20.

The observation point 21 (21a, 21b, 21c) is a point at which the displacements of the substructures 20a to 20c are observed. The displacement observed at the observation points 21a to 21c is desirably a displacement in a direction suitable for the purpose of confirming the soundness of the substructures 20a to 20c. For example, when the structure is a bridge, displacement in the vertical direction is desirable. In addition, when the structure is a building, displacement in the horizontal direction is desirable.

The sensors (not illustrated) that are arranged at the observation points 21a to 21c and observe displacement are, for example, contact sensors, non-contact sensors, and the like. Alternatively, remote sensing such as satellite synthetic aperture radar (SAR) may be used. Note that the sensor that observes the displacement of the observation point 21 transmits the displacement data to the information processing apparatus 10 via the communication network.

The network is, for example, a general communication network constructed using a communication line such as the Internet, a local area network (LAN), a dedicated line, a telephone line, an intra-company network, a mobile communication network, Bluetooth (registered trademark), or wireless fidelity (WiFi).

The storage device 30 is a database, a server computer, a memory, or the like. The storage device 30 stores, for example, various types of information. In the example of FIG. 2, the storage device 30 is provided outside the information processing apparatus 10, but may be provided inside the information processing apparatus 10.

The output device 40 acquires output information converted into a format that can be output by the output information generation unit 16, and outputs an image, sound, and the like generated based on the output information. The output device 40 is, for example, an image display device using liquid crystal, organic electro luminescence (EL), or a cathode ray tube (CRT). Moreover, the image display device may include, for example, a sound output device such as a speaker. The output device 40 may be a printing device such as a printer. The output information will be described later.

Details of the information processing apparatus will be described.

The collection unit 15 collects measurement data (displacement data) transmitted from each of the plurality of observation points 21 (21a, 21b, 21c) of the substructure 20 (20a, 20b, 20c) via a network by using wired communication, wireless communication, or the like. Next, the collection unit 15 stores the measurement data in the storage device 30.

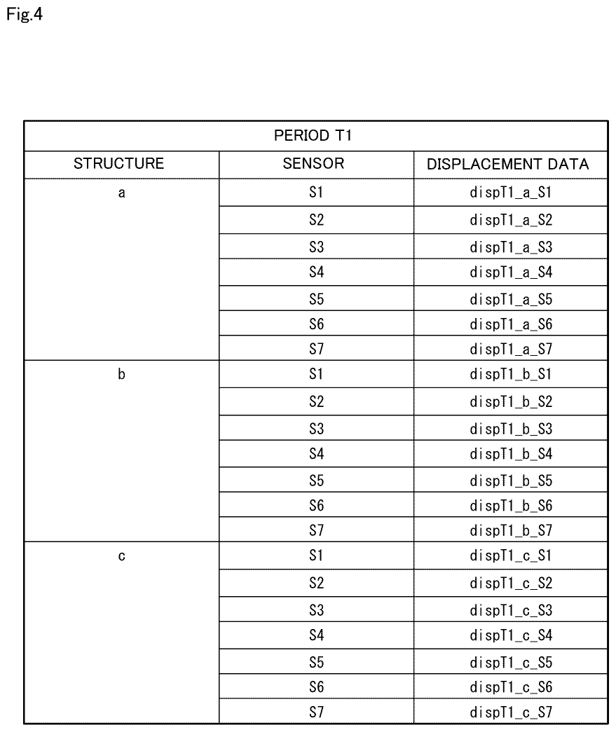

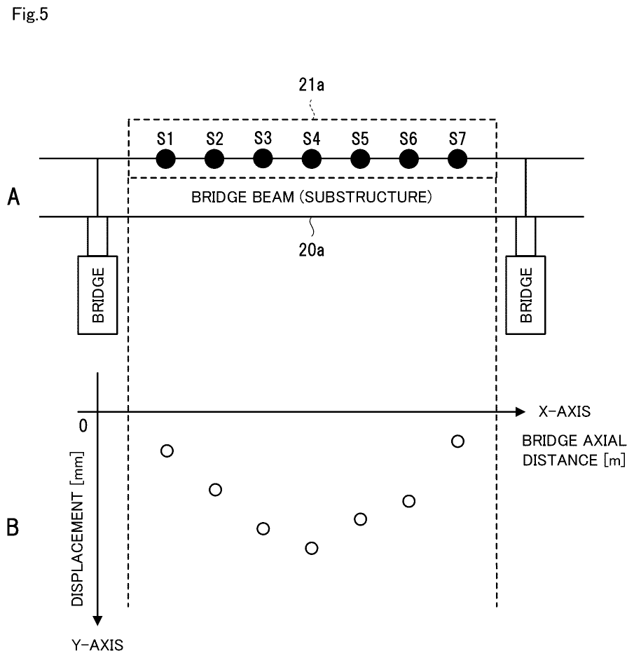

The displacement data will be described with reference to FIGS. 4 and 5. FIG. 4 is a diagram for describing an example of the displacement data. FIG. 5 is a diagram for describing an example of graphing of the displacement data.

FIG. 4 is an example of measurement data (displacement data) of the substructure 20 (20a, 20b, 20c) measured at the observation point 21 (21a, 21b, 21c). FIG. 4 includes measurement data (displacement data) at the measurement timing T1. In addition, in the example of FIG. 4, only one measured period is illustrated, but there is actually a plurality of periods. The displacement data shown in FIG. 4 is represented by a label instead of a numerical value. For example, the label “dispT1_a_s1” indicates measurement data (displacement data) measured at the observation position S1 of the observation point 21a of the substructure 20a at the measurement timing T1.

FIG. 5 is a graph illustrating a relationship between observation positions S1 to S7 (●: black dot) and displacement data (○: white dot) at the observation point 21a. The horizontal axis (X axis) of the graph in B of FIG. 5 represents the distance from the bridge pier on the left side of FIG. 5 to the observation positions S1 to S7. In B of FIG. 5, this distance is expressed as a bridge axial distance. The vertical axis (Y axis) of the graph in B of FIG. 5 represents a value of displacement data, and represents displacement in which the downward direction increases vertically downward.

The reference displacement calculation unit 11 calculates reference displacement data based on displacement data, measured in a target period defined by a user, of at least one substructure similar to an evaluation target substructure constituting a target structure.

Specifically, the reference displacement calculation unit 11 acquires, from the storage device 30, a plurality of pieces of displacement data measured using the observation points 21b and 21c of the substructures 20b and 20c similar to the evaluation target structure 20a set in advance.

For example, in a substructure similar to a span (substructure) as an evaluation target of the bridge A as an evaluation target, a span (substructure) adjacent to the span as an evaluation target is considered as a first candidate (substructure similar to the evaluation target substructure). However, if the structural form of the span (for example, a box beam, an arch bridge, or the like), the span length, and the like are similar, the span of another bridge (for example, bridges B, C, and the like) may be set as the second candidate (a substructure similar to the evaluation target substructure).

Next, the reference displacement calculation unit 11 calculates reference displacement data to be used for soundness diagnosis based on a preset calculation condition for the acquired displacement data (reference displacement calculation processing). Next, the reference displacement calculation unit 11 stores the reference displacement data in the storage device 30.

The calculation condition is, for example, a process of calculating an average value for the displacement data corresponding to the observation point in the central portion of the span acquired for each substructure.

The reference displacement calculation processing will be described. The reference displacement calculation unit 11 calculates reference displacement data using displacement data of predetermined representative positions of a plurality of substructures other than the evaluation target substructure.

The predetermined representative position is, for example, a central position where the largest displacement occurs at the observation points 21a to 21c. The reason is that the place where the largest displacement occurs is suitable for calculating the reference displacement data. That is, the reference displacement calculation unit 11 may calculate the reference displacement data using the displacement data of the observation position closest to the center position of the observation points 21a to 21c.

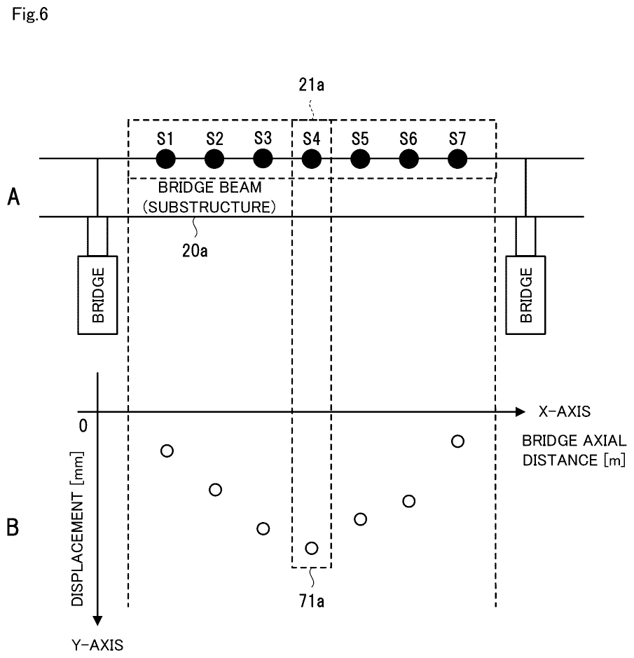

FIG. 6 is a diagram for describing an example of a relationship between displacement data and reference displacement data in calculation of reference displacement data. In the example of FIG. 6, the center position of the observation point 21a is a region of a dotted line 7a.

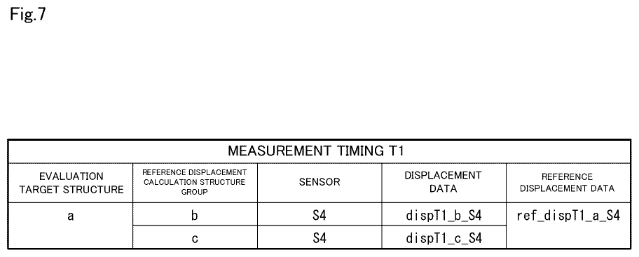

FIG. 7 is a diagram for describing an example of calculation of the reference displacement data. A case where the evaluation target structure is 20a, the structures other than the evaluation target are 20b and 20c, and the center positions of the observation points 21b and 21c are predetermined representative positions will be described with reference to FIG. 7.

In the example of FIG. 7, the displacement data of the central position (S4) of the observation point 21b is represented by “dispT1_b_S4”. The displacement data of the center position (S4) of the observation point 21c is represented by “dispT1_c_S4”. The reference displacement calculation unit 11 calculates an arithmetic mean of the displacement data “dispT1_b_S4” and “dispT1_c_S4” to calculate reference displacement data “ref_dispT1_a_S4”. In the example of FIG. 7, only one label indicating the displacement data of the center position (S4) of the observation points 21b and 21c is provided, but a plurality of labels may be provided. In FIG. 7, “ref_dispT1_a_S4” represents reference displacement data.

Another example of the predetermined representative position will be described. The predetermined representative position may be provided, for example, in a region of ±5 [%] of the central position of the observation point 21 (21a to 21c). That is, the reference displacement calculation unit 11 may calculate the reference displacement data using the displacement data of the observation positions (S1 to S7) included in the region of ±5 [%] of the central positions of the observation points 21a to 21c. However, the region is not limited to ±5 [%], and may be other than ±5 [%] (for example, it may be smaller than ±5 [%] or larger than ±5 [%]).

The reference displacement data is, for example, an arithmetic mean, a geometric mean, a weighted mean, a median, a mode, or the like. Note that, in a case where the lengths of the substructures 20a to 20c similar to each other are slightly different, a weighted average weighted by the lengths of the substructures 20a to 20c may be used in order to offset the influence of the difference in length on the displacement.

In addition, it is difficult to consider that anomalies occur simultaneously and frequently in a plurality of substructures other than the evaluation target, and the plurality of substructures other than the evaluation target is affected by the same environment as that of the evaluation target substructure. Therefore, the reference displacement data can be calculated even using the displacement data of the predetermined representative positions of the plurality of substructures other than the evaluation target.

The difference calculation unit 12 calculates displacement difference data between displacement data (evaluation target displacement data) of a predetermined portion in the evaluation target substructure and reference displacement data in the target period.

Specifically, the difference calculation unit 12 first acquires displacement data (evaluation target displacement data) of the observation point 21a of the structure 20a as an evaluation target and reference displacement data from the storage device 30. Next, the difference calculation unit 12 calculates a difference between the displacement data and the reference displacement data (difference calculation processing). Thereafter, the difference calculation unit 12 stores displacement difference data for the structure 20a as an evaluation target in the storage device 30.

The difference calculation processing will be described. A case where the evaluation target is the substructure 20a and the reference displacement data calculated by the reference displacement calculation unit 11 is “ref_dispT1_a_S4” will be described. In the example of FIG. 7, the difference calculation unit 12 calculates displacement difference data Δd (=“dispT1_a_S4”−“ref_dispT1_a_S4”).

The estimation unit 13 estimates a probability distribution of a displacement difference of the evaluation target substructure using the displacement difference data.

Specifically, the estimation unit 13 first acquires displacement difference data for the structure 20a from the storage device 30. Next, the estimation unit 13 estimates a probability distribution using the displacement difference data (probability distribution estimation processing). Thereafter, the estimation unit 13 stores probability distribution information indicating the estimated probability distribution in the storage device 30.

The probability distribution estimation process will be described. The estimation unit 13 creates a frequency distribution of the displacement difference data calculated by the difference calculation unit 12 and estimates a probability distribution close to the frequency distribution. For example, the kernel density estimation or the Gaussian fitting is used to estimate the probability distribution.

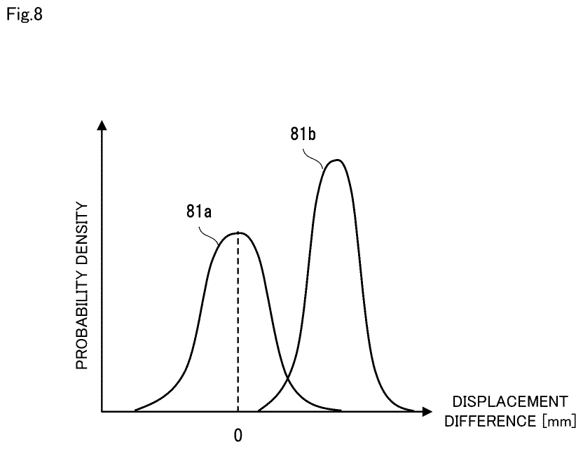

FIG. 8 is a diagram for describing an example of a probability distribution of a displacement difference. In FIG. 8, the vertical axis represents the probability density, and the horizontal axis represents the displacement difference [mm]. A curve 81a is a mean zero probability distribution, and a curve 81b is a probability distribution with non-zero mean. That is, the curve 81a represents the probability distribution of the displacement difference in which the measurement data is the sound value (displacement difference≈0). A curve 81b represents a probability distribution of a displacement difference when an abnormal value occurs in the measurement data.

Note that the fact that the displacement difference with respect to the reference displacement has a probability distribution with zero mean means that a displacement close to the reference displacement has occurred in the evaluation target substructure. On the other hand, the probability distribution with non-zero mean means that a displacement different from the reference displacement occurs.

The diagnosis unit 14 performs statistical analysis processing using the estimated probability distribution of the displacement difference and diagnoses soundness of the substructure based on a processing result.

Specifically, the diagnosis unit 14 first acquires the probability distribution of the displacement difference from the storage unit 30. Next, the diagnosis unit 14 diagnoses the soundness of the evaluation target substructure 20 using the acquired probability distribution of the displacement difference (soundness diagnosis processing). Next, the diagnosis unit 14 stores the diagnosis result in the storage device 30.

Here, in the probability distribution, how much the displacement of the evaluation target substructure is different from the reference displacement can be regarded as a determination index. Since the reference displacement is a value calculated from the displacement of a substructure having another similar structural form that is not the evaluation target substructure, the reference displacement is affected by the same environmental factor.

Therefore, if there is no abnormality in the displacement of the evaluation target substructure, the displacement is assumed to have a value similar to the reference displacement. Conversely, if there is an abnormality in the displacement of the evaluation target substructure, the displacement is assumed to have a value different from the reference displacement. Note that this assumption is based on the assumption that multiple anomalies do not occur simultaneously.

According to the above idea, it can be considered as a soundness index (soundness diagnosis result) indicating how close the average value of the probability distribution of the displacement difference of the evaluation target substructure is to zero mean (value indicating soundness).

Specifically, the soundness diagnosis processing is processing of executing a verification processing of calculating a distance between the average value of the probability distribution and a preset zero (value indicating soundness), and diagnosing whether there is an abnormality (aged deterioration, damage, etc.) in the displacement of the evaluation target substructure 20 based on the processing result of the verification processing.

Alternatively, in the soundness diagnosis processing, the structure parameter of the substructure 20 may be estimated by statistical analysis processing of reproducing the probability distribution by simulation, and whether there is an abnormality of the substructure may be diagnosed.

Alternatively, when a significant difference is observed in the average value by a t-test of a difference between the average values by t values (=(average−0)/(variance/sample size)^{1/2}) calculated by the average and the variance of the probability distribution, it may be considered that the average value is deteriorated, and the soundness may be diagnosed. Here, for example, a significance level 5 [%] may be set as a guide of whether deterioration occurs.

The output information generation unit 16 outputs the information stored in the storage device 30 to the output device 40. The information may be any one or more of a structure of the structure 20a (see FIG. 3), displacement data at the observation point 21a (see FIG. 4), a graph of the displacement data (see FIG. 5), reference displacement data (see FIG. 7), a displacement difference between the displacement data and the reference displacement data at the observation point 21a, a probability distribution of the displacement difference (see FIG. 8), and a diagnosis result of soundness.

### First Modified Example

Hereinafter, the first modified example of the example embodiment will be described.

In the example embodiment, the reference displacement calculation unit 11 and the difference calculation unit 12 calculate the reference displacement data and the displacement difference data using the measurement data (displacement data) at the observation point 21.

On the other hand, in the first modified example, the reference displacement calculation unit 11 and the difference calculation unit 12 do not directly use the measurement data (displacement data) of the observation point 21, but perform curve fitting using the measurement data (displacement data) to obtain a displacement function. Then, a value (displacement data) is obtained for each observation point 21 on the basis of the displacement function obtained by curve fitting.

The displacement function provides displacement data at an arbitrary position of the observation point 21. The function used for curve fitting is, for example, a polynomial or a trigonometric function.

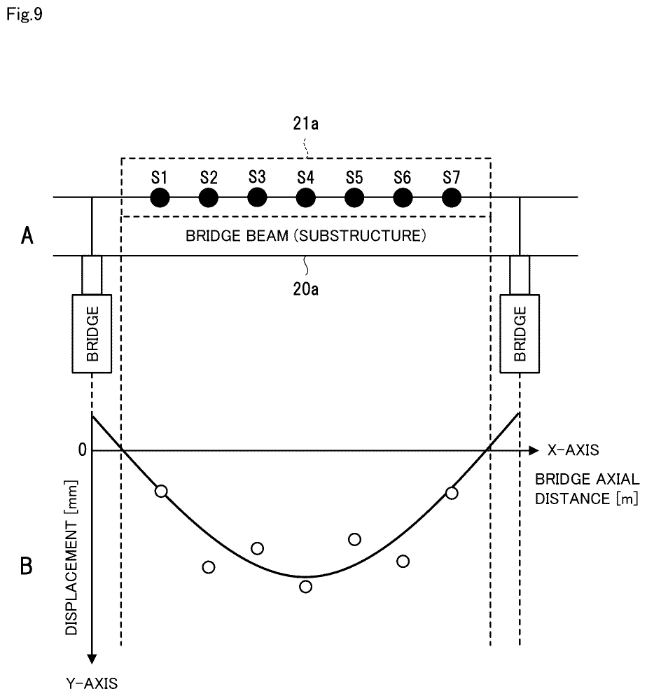

Calculation of the probability distribution of the first modified example will be described with reference to FIG. 9. FIG. 9 is a diagram for describing an example of a displacement function obtained by curve fitting of displacement data in the first modified example. FIG. 9A illustrates the observation point 21a (●: black dot) of the structure 20a as an evaluation target. FIG. 9B illustrates an example of the displacement function 91a with respect to the measurement data (displacement data) (○: white dot) of the observation point 21a. Note that, similarly to the example embodiment, in the first modified example, the probability distribution of the displacement difference is estimated at a predetermined representative position of the observation point 21.

### Second Modified Example

A second modified example in which the first modified example is further modified will be described.

In the second modified example, the average of the normal distribution or the variance of the normal distribution is estimated assuming that the probability distribution of the displacement difference is the normal distribution. Note that, similarly to the first modified example, in the second modified example, the probability distribution of the displacement difference is estimated at the predetermined representative position of the observation point 21.

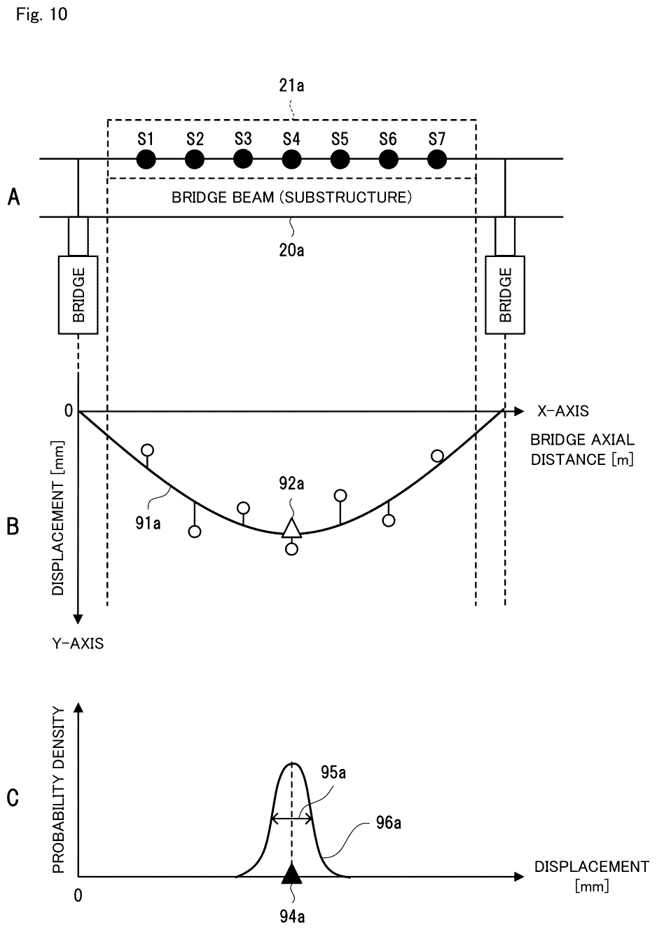

Calculation of the probability distribution of the displacement difference of the second modified example will be described with reference to FIG. 10. FIG. 10 is a diagram for describing an example of a probability distribution of a displacement difference in the second modified example. FIG. 10A illustrates the observation point 21a (●: black dot) of the evaluation target substructure 20a. FIG. 10B illustrates an example of the displacement function 91a with respect to the displacement data (○: white dot) of the observation point 21a. FIG. 10C illustrates a probability distribution of the displacement difference estimated by the estimation unit 13 of the second modified example.

In the second modified example, similarly to the first modified example, the reference displacement calculation unit 11 calculates the reference displacement data using the value (displacement data) obtained based on the displacement function. As in the first modified example, the difference calculation unit 12 calculates the displacement difference data using the value (displacement data) obtained based on the displacement function and the reference displacement data.

Furthermore, in the second modified example, for example, the estimation unit 13 estimates a displacement difference 94a (average of normal distribution in FIG. 10C) between the reference displacement data and a value 92a (displacement data) of the displacement function at the center position (S4) of the observation point 21a.

Alternatively, in the second modified example, for example, the estimation unit 13 may estimate the unbiased variance (the variance 95a of the normal distribution 96a in FIG. 10C) from at least two or more differences of the difference 93a between the measurement data and the value of the displacement function at the predetermined position (S1 to S7) of the observation point 21a.

### Third Modified Example

A third modified example obtained by further modifying the second modified example will be described.

In the third modified example, the estimation unit 13 estimates the probability distribution of the displacement difference by regarding the probability distribution as a function that changes depending on the observation position of the observation point 21a. The probability distribution of the displacement difference is assumed to be a normal distribution as in the second modified example. The estimation unit 13 of the third modified example estimates the average and variance of the normal distribution as a function of the observed position of the observation point 21a.

In the third modified example, one arbitrary position among the observation points 21a is taken, and the variance of the probability distribution at the position is calculated from the difference 93a between all the measurement data (S1 to S7) of the observation point 21a and the value of the displacement function. In other words, the variance of the probability distribution of the displacement difference is determined regardless of the observation position.

However, in the case of a bridge, it is assumed that a change in displacement is large at a central portion of a span, and a change in displacement is small at a portion fixed to the ground such as an end portion (bridge pier). Therefore, a mechanism in which the magnitude of the variance of the probability distribution of the displacement difference is adjusted according to the observation position may be adopted.

The average of the normal distribution at the observation position is a displacement difference function between the displacement function of the observation point 21a and the reference displacement.

The variance of the normal distribution at the observation position changes such that the variance becomes maximum at the center position of the observation point 21a and becomes minimum at the end of the observation point 21a according to the observation position of the observation point 21a, with the unbiased variance of the difference between the displacement data and the displacement function at the observation point 21a as a reference variance.

In the third modified example, the estimation unit 13 estimates the normal distribution having the average and the variance described above as the probability distribution of the displacement difference. By using such a probability distribution, a difference in displacement at each place of the observation point 21a can be reflected in the diagnosis of soundness.

As described above, unlike the example embodiment and the first and second modified examples, in the third modified example, the probability distribution of the displacement difference at an arbitrary observation position of the observation point 21a is estimated as a function.

### Fourth Modified Example

A fourth modified example in which the third modified example is further modified will be described.

In the fourth modified example, the diagnosis unit 14 may diagnose the soundness of the substructure by estimating the structure parameter of the substructure by statistical analysis processing of reproducing the probability distribution described in the third modified example by structure simulation.

As the statistical analysis processing described above, for example, it is conceivable to use a Markov chain Monte Carlo method or the like. In the Markov chain Monte Carlo method (MCMC), a posterior probability distribution P(θ|X)=P(X|θ)P(θ)/P(X) of θ, expressed by a probability distribution P(X) of observed data X, a conditional probability distribution P(X|θ) of the observed data X, and a prior probability distribution P(θ) of an unobserved parameter θ is estimated for an observation target including the observed data X and the unobserved parameter θ by random selection and repetition of simulation.

P(X) is obtained from the observed data. P(θ) is set based on general knowledge about the observation target, and a uniform distribution is often used. P(X|θ) is calculated by simulation of the observation target. This is because P(X|θ) is the probability distribution of the observed data X on the assumption of the unobserved parameter θ, and thus it is not practical to obtain P(X|θ) from the observed data.

When the above description is applied to the application example, the observation target is the structure, the observed data X is the displacement data, P(X) is the probability distribution calculated from displacement difference data, the unobserved parameter θ is a structure parameter (an elastic modulus, a spring constant, a density, or the like of a member) of the structure, and P(X|θ) is a probability distribution of displacement difference data of the structure calculated by structure simulation.

That is, since the posterior probability distribution of the structure parameter of the structure is obtained by the statistical analysis processing called MCMC, the soundness diagnosis using the posterior probability distribution is possible. For example, it can be diagnosed that there is an abnormality when an average value of the posterior probability distribution of the structure parameter is smaller than a nominal value of the structure parameter, and it can be diagnosed that there is an abnormality in either Member A or Member B having a significantly smaller posterior probability distribution of the structure parameter by comparison.

When the structure simulation is performed on the structure 20, the displacement corresponding to each observation position included in the observation point 21 is calculated. In this calculation, a structure model simulating a structural form of the structure 20 is used. Further, settings representing aging, damage, or the like may be added in order to bring the structure model close to a state of the structure 20.

The structure simulation may be performed, for example, inside the information processing apparatus 10 or may be performed by another information processing apparatus provided outside the information processing apparatus 10.

Next, the reference displacement calculation unit 11, the difference calculation unit 12, and the estimation unit 13 in the application example perform processing similar to the above-described example embodiment. The diagnosis unit 14 of the modified example diagnoses the soundness of the state of the structure by the statistical analysis processing such as the MCMC. The contents of the diagnosis are as described above.

When the reference displacement calculation unit 11, the difference calculation unit 12, and the estimation unit 13 estimate a plurality of probability distributions corresponding to a plurality of observation positions included in the observation point 21a, the diagnosis unit 14 of the modified example may diagnose the soundness of the state of the structure by statistical analysis processing such as MCMC using the plurality of probability distributions.

Next, the output information generation unit 16 of the modified example generates output information used to output a structure of the structure 20 (see FIGS. 3), pieces of displacement data (see FIG. 4) measured by the observation points 21 and a graph of pieces of the displacement data (see FIG. 5), pieces of displacement data being extracted (extracted displacement data) and the reference displacement data of the observation points 21 (see FIG. 7) and a graph of pieces of the extracted displacement data (see FIG. 6), a probability distribution (see FIG. 8), or a diagnosis result, or two or more of these pieces of information to the output device 40. Then, the output information generation unit 16 outputs the generated output information to the output device 40.

Further, the output information generation unit 16 of the modified example generates output information used to output the structure model, pieces of displacement data generated by a simulator and a graph of pieces of the displacement data, pieces of extracted displacement data generated by the simulator and a graph of pieces of the extracted displacement data, a probability distribution generated by the simulator, or a diagnosis result, or two or more of these pieces of information to the output device 40.

When the fourth modified example is used, it is possible to obtain an effect that which member of the structure is in what degree of degradation state can be estimated by selecting how to perform the structure simulation and any structure parameter to be estimated. This is the effect that cannot be obtained in the above-described example embodiment.

### [Apparatus Operation]

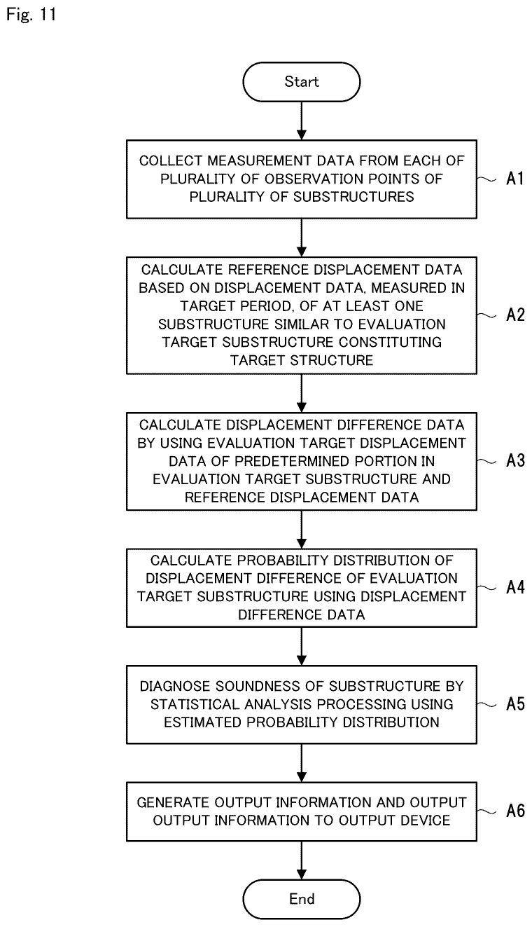

Next, an operation of the information processing apparatus according to the example embodiment will be described with reference to FIG. 11. FIG. 11 is a diagram for describing an example of the operation of the information processing apparatus. In the following description, the drawings are appropriately referred to. In the example embodiment, by operating the information processing apparatus, an information processing method is implemented. Therefore, description of the information processing method according to the example embodiment is substituted with the description of the operation of the information processing apparatus below.

As illustrated in FIG. 11, first, the collection unit 15 collects measurement data (displacement data) measured at a plurality of observation points of the substructure (step A1).

Specifically, in step A1, the collection unit 15 first collects measurement data (displacement data) transmitted from each of the plurality of observation points 21a, 21b, and 21c of the plurality of substructures 20a, 20b, and 20c via a network by using wired communication, wireless communication, or the like. Next, in step A1, the collection unit 15 stores pieces of the displacement data in the storage device 30. The collection unit 15 adds information indicating a collection timing to the measurement data such that a timing when the measurement data has been collected can be specified.

Next, the reference displacement calculation unit 11 calculates reference displacement data based on displacement data, measured in a target period defined by a user, of at least one substructure similar to an evaluation target substructure constituting a target structure (step A2).

Specifically, in step A2, the reference displacement calculation unit 11 first acquires, from the storage device 30, a plurality of pieces of displacement data measured using the observation points 21b and 21c of the substructures 20b and 20c similar to the evaluation target substructure 20a other than the evaluation target substructure 20a set in advance.

Next, in step A2, the reference displacement calculation unit 11 calculates reference displacement data to be used for diagnosis of soundness for each acquired displacement data based on a preset calculation condition (reference displacement calculation processing). Next, in step A2, the reference displacement calculation unit 11 stores the pieces of the reference displacement data in the storage device 30.

Next, the difference calculation unit 12 calculates displacement difference data by using displacement data of a predetermined portion (evaluation target displacement data) in the evaluation target substructure and the reference displacement data (step A3).

Specifically, in step A3, the difference calculation unit 12 first acquires displacement data (evaluation target displacement data) of the observation point 21a of the structure 20a as an evaluation target and reference displacement data from the storage device 30. Next, in step A3, the difference calculation unit 12 calculates a difference between the evaluation target displacement data and the reference displacement data (difference calculation processing). Next, in step A3, the difference calculation unit 12 stores displacement difference data for the structure 20a as an evaluation target in the storage device 30.

Next, the estimation unit 13 calculates a probability distribution of the displacement difference of the evaluation target substructure corresponding to the target period using the displacement difference data (step A4).

Specifically, in step A4, the estimation unit 13 first acquires displacement difference data for the structure 20a from the storage device 30. Next, in step A4, the estimation unit 13 estimates a probability distribution using the displacement difference data (probability distribution estimation processing). Next, in step A4, the estimation unit 13 stores probability distribution information representing the estimated probability distribution in the storage device 30.

Next, the diagnosis unit 14 performs statistical analysis processing using the estimated probability distribution, and diagnoses the state soundness of the substructure 20 based on the processing result (step A5).

Specifically, in step A5, the diagnosis unit 14 first acquires probability distribution information of the estimated displacement difference from the storage device 30. Next, in step A5, the diagnosis unit 14 executes statistical analysis processing by using the probability distribution information, and determines whether the state of the structure 20 is statistically significantly different by using the result of the statistical analysis processing. Next, in step A5, the diagnosis unit 14 stores the soundness diagnosis result in the storage device 30.

Next, the output information generation unit 16 generates output information and outputs the output information to the output device (step A6). Specifically, in step A6, the output information generation unit 16 generates output information used to output a structure of the structure 20 (see FIG. 3), pieces of displacement data (see FIG. 4) measured by the observation points 21 and a graph of pieces of the displacement data (see FIG. 5), pieces of extracted displacement data and the reference displacement data of the observation points 21 (see FIG. 7) and a graph of pieces of the extracted displacement data (see FIG. 6), a probability distribution (see FIG. 8), or a diagnosis result, or two or more of these pieces of information to the output device 40. Next, in step A6, the output information generation unit 16 outputs the generated output information to the output device 40.

### [Effect of Example Embodiment]

As described above, according to the example embodiment and the first to fourth modified examples, since the displacement difference between the reference displacement measured from the structure other than the evaluation target and the displacement of the evaluation target belonging to the group including the plurality of structures in which the plurality of factors that may affect the behavior of the structure are similar is used, it is possible to diagnose the soundness of the structure using only the displacement caused by the influence of the damage.

In other words, since the deflection (displacement) of the structure is caused by the synthetic influence of factors such as damage, temperature, and active load, only the displacement caused by the influence of the damage can be calculated from the original displacement of the evaluation target by using the displacement measured from the structure other than the evaluation target in which a plurality of factors that may affect the behavior of the structure are similar. Actually, it is difficult to estimate and remove the displacement caused by a factor (temperature or active load) other than the damage from the original displacement of the evaluation target, but in the example embodiment, it is possible to estimate only the displacement due to the influence of the damage and diagnose the soundness of the structure.

### [Program]

It is sufficient for a program according to the example embodiment and the first to fourth modified examples to be a program that causes a computer to execute steps A1 to A6 illustrated in FIG. 11. When the program is installed and executed in the computer, the information processing apparatus and the information processing method according to the example embodiment and the first to fourth modified examples can be achieved. In this case, a processor of the computer functions as the collection unit 15, the reference displacement calculation unit 11, the difference calculation unit 12, the estimation unit 13, the diagnosis unit 14, and the output information generation unit 16, and performs processing.

The program according to the example embodiment and the first to fourth modified examples may be executed by a computer system constructed by a plurality of computers. In this case, for example, each of the computers may function as any of the collection unit 15, the reference displacement calculation unit 11, the difference calculation unit 12, the estimation unit 13, the diagnosis unit 14, and the output information generation unit 16.

### [Physical Configuration]

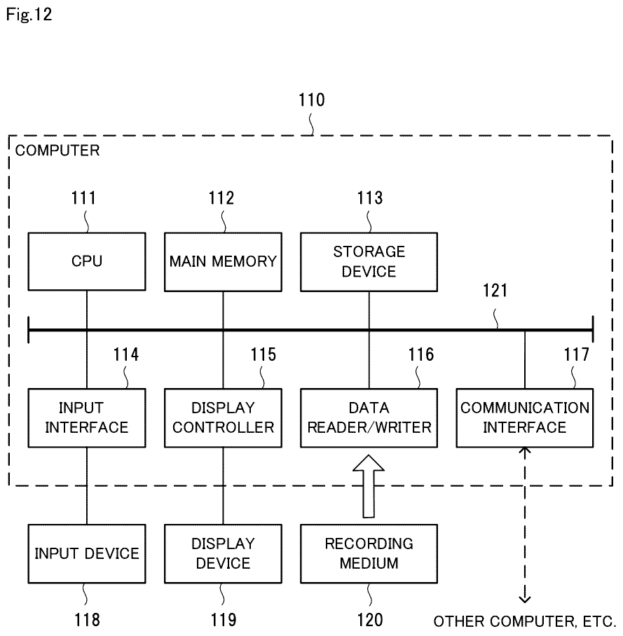

Here, the computer that achieves the information processing apparatus by executing the program according to the example embodiment and the first to fourth modified examples will be described with reference to FIG. 12. FIG. 12 is a diagram for describing an example of the computer that achieves the information processing apparatus according to the example embodiment and the first to fourth modified examples.

As illustrated in FIG. 12, a computer 110 includes a CPU 111, a main memory 112, a storage device 113, an input interface 114, a display controller 115, a data reader/writer 116, and a communication interface 117. These units are data-communicably connected to each other via a bus 121. The computer 110 may include a GPU or an FPGA in addition to the CPU 111 or instead of the CPU 111.

The CPU 111 loads the program according to the example embodiment, which is stored in the storage device 113 and includes codes, into the main memory 112, and executes each code in a predetermined order to perform various operations. The main memory 112 is typically a volatile storage device such as a dynamic random access memory (DRAM).

The program according to the example embodiment is provided in a state of being stored in a computer-readable recording medium 120. Then, the program in the example embodiment may be distributed on the Internet connected via the communications interface 117.

Specific examples of the storage device 113 include a semiconductor storage device such as a flash memory in addition to a hard disk drive. The input interface 114 mediates data transmission between the CPU 111 and the input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result of the computer 110 into the recording medium 120. The communications interface 117 mediates data transmission between the CPU 111 and another computer.

Specific examples of the recording medium 120 include general-purpose semiconductor storage devices such as CompactFlash (CF) (registered trademark) and a secure digital (SD), a magnetic recording medium such as a flexible disk (flexible disk), and an optical recording medium such as a compact disk read only memory (CD-ROM).

The information processing apparatus 10 in the example embodiment can also be achieved using hardware related to each unit, for example, an electronic circuit, instead of a computer in which a program is installed. Moreover, a part of the information processing apparatus 10 may be achieved by a program, and the remaining part may be achieved by hardware. In the example embodiment, the computer is not limited to the computer illustrated in FIG. 12.

While the invention has been particularly shown and described with reference to example embodiments thereof, the invention is not limited to these example embodiments. Various modified examples that can be understood by those skilled in the art can be made to the configuration and details of the invention within the scope of the invention.

Some or all of the above-described example embodiments can be expressed by (Supplementary Note 1) to (Supplementary Note 15) described below, but are not limited to the following description.

### (Supplementary Note 1)

An information processing apparatus including
a reference displacement calculation unit for calculating reference displacement data based on displacement data, measured in a target period, of at least one substructure similar to an evaluation target substructure constituting a target structure,
a difference calculation unit for calculating displacement difference data by using evaluation target displacement data of a predetermined portion in the evaluation target substructure and the reference displacement data,
an estimation unit for estimating a probability distribution of a displacement difference of the evaluation target substructure using the displacement difference data, and
a diagnosis unit for performing statistical analysis processing using the estimated probability distribution of the displacement difference and diagnosing soundness of the substructure based on a processing result.

### (Supplementary Note 2)

The information processing apparatus according to Supplementary Note 1, in which the reference displacement calculation unit calculates reference displacement data using measurement data for each of the substructures as the displacement data.

### (Supplementary Note 3)

The information processing apparatus according to Supplementary Note 1, in which the reference displacement calculation unit calculates reference displacement data using a value of a displacement function obtained by curve fitting using measurement data for each of the substructures as the displacement data.

### (Supplementary Note 4)

The information processing apparatus according to Supplementary Note 3, in which the estimation unit estimates, as the probability distribution of the displacement difference, a normal distribution having an average of the normal distribution that is a displacement difference calculated using the value of the displacement function and the reference displacement data and a variance of the normal distribution that is an unbiased variance of a difference between the measurement data and the value of the displacement function.

### (Supplementary Note 5)

The information processing apparatus according to Supplementary Note 1, in which the statistical analysis processing is carried out by a Markov chain Monte Carlo method.

### (Supplementary Note 6)

An information processing method including, by an information processing apparatus,
calculating reference displacement data based on displacement data, measured in a target period, of at least one substructure similar to an evaluation target substructure constituting a target structure,
calculating displacement difference data by using evaluation target displacement data of a predetermined portion in the evaluation target substructure and the reference displacement data,
estimating a probability distribution of a displacement difference of the evaluation target substructure using the displacement difference data, and
performing statistical analysis processing using the estimated probability distribution of the displacement difference and diagnosing soundness of the substructure based on a processing result.

### (Supplementary Note 7)

The information processing method according to Supplementary Note 6, in which the reference displacement data is calculated using measurement data for each of the substructures as the displacement data.

### (Supplementary Note 8)

The information processing method according to Supplementary Note 6, in which the reference displacement data is calculated using a value of a displacement function obtained by curve fitting using measurement data for each of the substructures as the displacement data.

### (Supplementary Note 9)

The information processing method according to Supplementary Note 8, in which a normal distribution having an average of a normal distribution that is a displacement difference calculated using the value of the displacement function and the reference displacement data and a variance of the normal distribution that is an unbiased variance of a difference between the measurement data and the value of the displacement function, is estimated as the probability distribution of the displacement difference.

### (Supplementary Note 10)

The information processing method according to Supplementary Note 6, in which the statistical analysis processing is carried out by a Markov chain Monte Carlo method.

### (Supplementary Note 11)

A computer-readable recording medium storing a program causing a computer to
calculate reference displacement data based on displacement data, measured in a target period, of at least one substructure similar to an evaluation target substructure constituting a target structure,
calculate displacement difference data by using evaluation target displacement data of a predetermined portion in the evaluation target substructure and the reference displacement data,
estimate a probability distribution of a displacement difference of the evaluation target substructure using the displacement difference data, and
perform statistical analysis processing using the estimated probability distribution of the displacement difference and diagnose soundness of the substructure based on a processing result.

### (Supplementary Note 12)

The computer-readable recording medium according to Supplementary Note 11, in which the reference displacement data is calculated using measurement data for each of the substructures as the displacement data.

### (Supplementary Note 13)

The computer-readable recording medium according to Supplementary Note 11, in which the reference displacement data is calculated using a value of a displacement function obtained by curve fitting using measurement data for each of the substructures as the displacement data.

### (Supplementary Note 14)

The computer-readable recording medium according to Supplementary Note 13, in which a normal distribution having an average of a normal distribution that is a displacement difference calculated using the value of the displacement function and the reference displacement data and a variance of the normal distribution that is an unbiased variance of a difference between the measurement data and the value of the displacement function, is estimated as the probability distribution of the displacement difference.

(supplementary Note 15)

The computer-readable recording medium according to Supplementary Note 11, in which the statistical analysis processing is carried out by a Markov chain Monte Carlo method.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

This application is based upon and claims the benefit of priority from Japanese patent application No. 2023-064663, filed on Apr. 12, 2023, the disclosure of which is incorporated herein in its entirety by reference.

### Industrial Applicability

According to the above description, it is possible to diagnose the soundness of the structure using the displacement due to the influence of the damage generated in the evaluation target structure. It is useful in the field where the diagnosis of the soundness of the structure is required.

### REFERENCE SIGNS LIST

10 information processing apparatus
11 reference displacement calculation unit
12 difference calculation unit
13 estimation unit
14 diagnosis unit
15 collection unit
16 output information generation unit
20, 20a, 20b, 20c substructure
21, 21a, 21b, 21c observation point
30 storage device
40 output device
100 system
110 computer
111 CPU
112 main memory
113 storage device
114 input interface
115 display controller
116 data reader/writer
117 communication interface
118 input device
119 display device
120 recording medium
121 bus

What is claimed is:

1. An information processing apparatus comprising:
at least one memory storing instructions; and
at least one processor configured to execute the instructions to:
calculate reference displacement data based on displacement data, measured in a target period, of at least one substructure similar to an evaluation target substructure constituting a target structure;
calculate displacement difference data by using evaluation target displacement data of a predetermined portion in the evaluation target substructure and the reference displacement data;
estimate a probability distribution of a displacement difference of the evaluation target substructure using the displacement difference data; and
perform statistical analysis processing using the estimated probability distribution of the displacement difference and diagnosing diagnose soundness of the substructure based on a processing result.

2. The information processing apparatus according to claim 1, wherein
the one or more processors further:
calculates reference displacement data using measurement data for each of the substructures as the displacement data.

3. The information processing apparatus according to claim 1, wherein
the one or more processors further:
calculates reference displacement data using a value of a displacement function obtained by curve fitting using measurement data for each of the substructures as the displacement data.

4. The information processing apparatus according to claim 3, wherein
the one or more processors further:
estimates, as the probability distribution of the displacement difference, a normal distribution having an average of the normal distribution that is a displacement difference calculated using the value of the displacement function and the reference displacement data and a variance of the normal distribution that is an unbiased variance of a difference between the measurement data and the value of the displacement function.

5. The information processing apparatus according to claim 1, wherein the statistical analysis processing is carried out by a Markov chain Monte Carlo method.

6. An information processing method comprising, by an information processing apparatus:
calculating reference displacement data based on displacement data, measured in a target period, of at least one substructure similar to an evaluation target substructure constituting a target structure;
calculating displacement difference data by using evaluation target displacement data of a predetermined portion in the evaluation target substructure and the reference displacement data;
estimating a probability distribution of a displacement difference of the evaluation target substructure using the displacement difference data; and
performing statistical analysis processing using the estimated probability distribution of the displacement difference and diagnosing soundness of the substructure based on a processing result.

7. A non-transitory computer-readable recording medium storing a program causing a computer to:
calculate reference displacement data based on displacement data, measured in a target period, of at least one substructure similar to an evaluation target substructure constituting a target structure;
calculate displacement difference data by using evaluation target displacement data of a predetermined portion in the evaluation target substructure and the reference displacement data;
estimate a probability distribution of a displacement difference of the evaluation target substructure using the displacement difference data; and
perform statistical analysis processing using the estimated probability distribution of the displacement difference and diagnose soundness of the substructure based on a processing result.

8. The information processing method according to claim 6, in which the reference displacement data is calculated using measurement data for each of the substructures as the displacement data.

9. The information processing method according to claim 6, in which the reference displacement data is calculated using a value of a displacement function obtained by curve fitting using measurement data for each of the substructures as the displacement data.

10. The information processing method according to claim 9, in which a normal distribution having an average of a normal distribution that is a displacement difference calculated using the value of the displacement function and the reference displacement data and a variance of the normal distribution that is an unbiased variance of a difference between the measurement data and the value of the displacement function, is estimated as the probability distribution of the displacement difference.

11. The information processing method according to claim 6, in which the statistical analysis processing is carried out by a Markov chain Monte Carlo method.

12. The non-transitory computer-readable recording medium according to claim 7, in which the reference displacement data is calculated using measurement data for each of the substructures as the displacement data.

13. The non-transitory computer-readable recording medium according to claim 7, in which the reference displacement data is calculated using a value of a displacement function obtained by curve fitting using measurement data for each of the substructures as the displacement data.

14. The non-transitory computer-readable recording medium according to claim 13, in which a normal distribution having an average of a normal distribution that is a displacement difference calculated using the value of the displacement function and the reference displacement data and a variance of the normal distribution that is an unbiased variance of a difference between the measurement data and the value of the displacement function, is estimated as the probability distribution of the displacement difference.

15. The non-transitory computer-readable recording medium according to claim 7, in which the statistical analysis processing is carried out by a Markov chain Monte Carlo method.
